(19) United States
(12) Patent Application Publication
(10) Pub. No.: US 2025/0153629 A1
(43) Pub. Date: May 15, 2025

(54) FLAT FLOOR-MAT FASTENING WITH HOOK-AND-LOOP ELEMENTS

(71) Applicant: Gottlieb Binder GmbH & Co. KG, Holzgerlingen (DE)

(72) Inventors: Lars HEEPE, Tübingen (DE); Konstantinos POULAKIS, Hildrizhausen (DE); Halvor TRAMSEN, Holzgerlingen (DE)

(73) Assignee: Gottlieb Binder GmbH & Co. KG, Holzgerlingen (DE)

(21) Appl. No.: 18/947,158

(22) Filed: Nov. 14, 2024

(30) Foreign Application Priority Data
Nov. 15, 2023 (DE) 10 2023 211 368.6

(51) Int. Cl. B60N 3/04; B32B 7/06; B32B 27/32; B32B 27/34; B32B 27/36; B60R 13/08

(52) U.S. Cl. CPC B60N 3/046; B32B 7/06; B60R 13/08; B32B 27/32; B32B 27/34; B32B 27/36; B32B 2307/54; B32B 2471/04; B32B 2605/003

(57) ABSTRACT

A floor mat assembly has a counter plate that is fastened to a floor covering. A connection system connects a base plate to the counter plate. The connection system is at least partly formed with an elastic connecting device. The connecting device is preferably formed on a side of the base plate and a side of the counter plate, these sides facing one another and lying opposite one another along a connection system axis perpendicular through these sides.

### CROSS REFERENCE TO RELATED APPLICATIONS

Applicant claims priority under 35 U.S.C. § 119 of German Application No. 10 2023 211 368.6 filed Nov. 15, 2023, the disclosure of which is incorporated by reference.

### BACKGROUND OF THE INVENTION

### 1. Field of the Invention

The invention relates to a floor mat assembly for a vehicle, the floor mat assembly having:
a floor covering;
a first hook-and-loop element having a base plate;
a counter plate which is at least partly disposed on the floor covering;
a floor mat;
a second hook-and-loop element which is at least partly disposed on a bottom side of the floor mat;
wherein the second hook-and-loop element is connected to the first hook-and-loop element by means of a hook-and-loop connection.

The invention also relates to a vehicle having such a floor mat assembly and to a method for producing such a floor mat assembly.

### 2. Description of the Related Art

From US 2015/0140261 A1, a floor mat assembly has become known in which a floor mat is fastened to a floor of a vehicle by means of hook-and-loop elements, one of the hook-and-loop elements being firmly glued to the floor. In a similar way, DE 10 2007 004 146 A1 teaches firmly gluing hook-and-loop plates disclosed therein to a vehicle floor in order to establish a firm connection between a floor mat and the vehicle floor. From DE 10 2010 042 284 A1 and DE 20 2014 101 483 U1, fastening floor mats by means of retaining elements which are anchored in holes in the floor of a vehicle compartment has become known.

Further arrangements of floor mats are disclosed in US 2017/0072823 A1, DE 82 21 629 U1, U.S. Pat. No. 5,215,348 A1, KR 200204204 Y1, EP 3 925 770 A2 and DE 89 11 331 U1.

However, especially in electrically powered vehicles, there is little installation space available in the floor of a vehicle due to the batteries.

### SUMMARY OF THE INVENTION

Therefore, the object of the present invention is to provide a floor mat assembly which requires little installation space and enables easier installation and removal of the floor mat assembly. The object of the invention is also to provide a vehicle having such a floor mat assembly. In addition, the object of the invention is to specify a method for producing such a floor mat assembly.

This object is achieved according to the invention by means of a floor mat assembly comprising a floor covering, a first hook-and-loop element having a base plate, a counter plate which is at least partly disposed on the floor covering, a floor mat, a second hook-and-loop element which is at least partly disposed on a bottom side of the floor mat, wherein the second hook-and-loop element is connected to the first hook-and-loop element by means of a hook-and-loop connection.

The floor mat assembly according to the invention is characterized in that a connection system connects the base plate and the counter plate to one another, the connection system having an elastic connecting device, the connecting device extending between mutually facing, in particular mutually parallel, sides of the base plate and of the counter plate.

In particular, the connecting device is formed on a side of the base plate and a side of the counter plate, these sides facing one another and lying opposite one another along a connection system axis perpendicular through these sides.

The arrangement of the connecting device between the base plate and the counter plate means that the floor mat assembly is compact, and the elastic connecting device facilitates, thanks to its flexible design, the installation and removal of the floor mat.

The sides of the base plate and of the counter plate between which the connecting device is formed run in particular parallel or at an acute angle to one another.

The term “side” refers in particular to a side face. The expression “at least partly” means in particular “partly or completely.”

The elastic connecting device has one or more elastic components which are used to connect the counter plate and the base plate, such as an elastic connecting web. The elastic connecting device preferably has a polymer having thermoplastic and/or elastic properties. In particular, the polymer is in the form of a thermoplastic polymer. The elastic connecting device typically has a polymer from the group of polyesters, polyamides and/or propylenes as material. Preferably, the connection system has the polymer that the connecting device has. Typical values of the modulus of elasticity of the elastic connecting device are in the range of 1000 N/mm² to 5000 N/mm², in particular 1300 N/mm² to 2500 N/mm². In particular, the elastic component has one of the aforementioned materials and/or moduli of elasticity. The elastic connecting device can be narrowed, in particular in portions that reach through a reach-through opening.

The connection system has the elastic connecting device and may also have further elastic and/or non-elastic components which are used to connect the counter plate and base plate.

The elastic component of the elastic connecting device can have a considerably lower elastic deformability when connected to other components of the connection system than when detached from the rest of the connection system.

The counter plate, the base plate and the elastic connecting device, in particular in the form of a connecting web, can be arranged or formed in a U-shape in some embodiments.

An advantageous embodiment of the floor mat assembly is characterized in that the base plate has a first locking element having a first locking portion and the counter plate has a second locking element having a second locking portion, wherein the elastic connecting device has at least one of the locking elements, wherein the locking portion of the locking element of the elastic connecting device is elastically pivotable and/or deformable, wherein the first locking element and the second locking element are locked together with the first locking portion abutting the second locking portion.

The installation of the floor mat on the second hook-and-loop element is advantageously carried out by connecting the first hook-and-loop element to the second hook-and-loop element and simply locking the first hook-and-loop element onto the counter plate. Conversely, the floor mat can be removed non-destructively by releasing this locking connection and releasing the hook-and-loop connection, without the need to release a material bond, such as an adhesive connection, which is comparatively time-consuming.

The position designations “top,” “bottom,” “top side,” “bottom side” and the like used here refer to the mounted state of the floor mat assembly in a vehicle.

An embodiment of the floor mat assembly is advantageous in which the first locking element together with the base plate of the first hook-and-loop element and/or the second locking element together with the counter plate has an extrusion profile having the associated locking portion, in particular is in the form of an extrusion profile. This allows the production of the locking elements to be particularly inexpensive and time-saving. An extrusion profile is understood to be, in particular, a component having a constant cross section.

The first hook-and-loop element may have mushroom-shaped projections which engage with mushroom-shaped projections of the second hook-and-loop element. Alternatively or additionally, the first hook-and-loop element can have hooks and the second hook-and-loop element can have loops. Preferably, the first hook-and-loop element has loops and the second hook-and-loop element has hooks, so that the floor covering has a visually uniform appearance together with the first hook-and-loop element when the floor mat is removed.

The mushroom-shaped projections, the hooks and/or the loops may be part of a band. The loops may be provided on a loop band, and/or the hooks may be provided on a hook band. In particular, the loops may be formed on a loop band, and/or the hooks may be formed on a hook band. The relevant band is preferably glued and/or welded onto an extrusion profile or the floor mat.

An embodiment of the floor mat assembly is preferred in which the first locking element protrudes from a surface of the first hook-and-loop element toward the counter plate and/or the second locking element protrudes from a surface of the counter plate toward the first hook-and-loop element. This results in a compact design of the locking connection of the first and second locking elements.

In an advantageous embodiment of the floor mat assembly, the first locking element and/or the second locking element has a locking arm, wherein each locking arm has a stem from which the associated locking portion protrudes. By means of a locking arm with the locking portion, the elastic deflectability and/or deformability of the locking portion can be achieved particularly easily.

In a further development of the aforementioned embodiment of the floor mat assembly, each relevant locking element has multiple locking arms, in particular two locking arms. Since in this further development multiple locking arms counteracts forces on the floor mat, the individual locking arms can have a lower load capacity than when only one locking arm of the relevant locking element is used. Therefore, the locking arms can, for example, be designed with a smaller material thickness. This allows the locking arms and thus the floor mat assembly to be designed particularly flat while maintaining high stability.

In a further embodiment of the floor mat assembly, the locking portion of the first locking element runs parallel to a side face of the first hook-and-loop element and/or the locking portion of the second locking element runs parallel to a side face of the counter plate, wherein the locking arm protrudes from the associated side face. This results in a stable locking connection when the locking arms engage with one another and the locking portions abut one another.

An embodiment of the floor mat assembly in which multiple, in particular mutually opposite, locking portions is formed on each locking arm, is advantageous. This increases the flexibility in the selection of the locking portions which are locked together.

Preferred is an embodiment of the floor mat assembly in which:
the floor covering has a reach-through opening;
the base plate is at least partly disposed on a top side of the floor covering;
the counter plate is at least partly disposed on a bottom side of the floor covering, which is opposite the top side of the floor covering;
the second hook-and-loop element is at least partly disposed on a bottom side of the floor mat;
wherein the connection system reaches through the reach-through opening.

The base plate and the counter plate can be fastened to the floor covering in a space- and material-saving manner by the leading of the connection system through the reach-through opening and by placement against the floor covering. By connecting the base plate to the floor covering with the help of the counter plate, preferably no holes or projections in the floor of a motor vehicle are necessary for fastening in order to firmly connect the floor mat to the floor. This allows the floor mat assembly to be designed flat, so that the installation space required by the floor mat assembly is small.

The elastic connecting device enables the base plate and the counter plate to be easily connected to one another and/or to be pressed against the floor covering in order to make the connection of the aforementioned plates to the floor covering more stable.

After the base plate has been fastened to the counter plate, the floor mat is easily fastened by connecting the first hook-and-loop element, which has the base plate, to the second hook-and-loop element, which is disposed on the floor mat. The second hook-and-loop element is preferably firmly connected to the floor mat. The floor mat assembly can thus be advantageously mounted in a space-saving and time-saving manner.

In a further development of the aforementioned embodiment of the floor mat assembly, the at least one locking element of the elastic connecting device is inserted into the reach-through opening.

This allows the locking elements to be connected in a particularly space-saving manner.

An embodiment of the floor mat assembly is advantageous in which the counter plate is at least partly fastened to the top side of the floor covering by material bond, in particular by means of an adhesive or a welded connection. This means that the counter plate is mounted particularly stably on the floor covering.

In a further development of the aforementioned embodiment, the connecting device is at least partly formed between the top side of the floor covering and the bottom side of the floor mat. This makes the connecting device comparatively easy to access.

An embodiment of the floor mat assembly is preferred in which the elastic connecting device has an elastic film hinge, wherein the elastic film hinge in particular connects the counter plate and the base plate to one another. This means that the first hook-and-loop element and the counter plate are stably connected to one another but can be flexibly oriented relative to one another to facilitate the handling of the first hook-and-loop element and the counter plate. Particularly preferably, the base plate, the counter plate and the connecting web are formed integrally with one another.

In an advantageous embodiment of the floor mat assembly, the counter plate and/or the first hook-and-loop element has a support projection which protrudes from the associated surface of the counter plate or of the first hook-and-loop element. The support projection serves in particular to support the first hook-and-loop element and the counter plate against each other. This better ensures the stability of the position and shape of the first hook-and-loop element and the counter plate in the floor mat assembly.

A preferred embodiment of the floor mat assembly is characterized in that the counter plate has a noise protection means. This suppresses any noise generated by the counter plate. The noise protection means can be in the form of a block, multiple blocks, and/or a coating. The noise protection means can have a soft and/or acoustically dampening material.

A vehicle according to the invention has an aforementioned floor mat assembly. In such a vehicle, the amount of installation space used for the floor mat assembly is small, and the floor mat assembly can be installed and removed in a time-saving manner.

In a preferred embodiment of the vehicle, the counter plate is firmly connected to a floor of the vehicle, in particular is formed integrally with the floor of the vehicle. This allows the floor mat assembly to be particularly space-saving and positionally stable.

The invention further has a method for producing a floor mat assembly for a vehicle, wherein the floor mat assembly has:
a floor covering (12);
a first hook-and-loop element (18) having a base plate (88);
a counter plate (38) which is at least partly disposed on the floor covering (12);
a floor mat (10);
a second hook-and-loop element (20) which is at least partly disposed on a bottom side (22) of the floor mat (10);
wherein the second hook-and-loop element (20) becomes connected to the first hook-and-loop element (18) by means of a hook-and-loop connection (36),
wherein the method is characterized in that
the base plate (88) and the counter plate (38) are or become connected to one another by means of a connection system,
wherein the connection system has an elastic connecting device (90), wherein the connecting device (90) extends between mutually parallel, mutually facing sides of the base plate (88) and of the counter plate (38).

This allows the floor mat to be arranged on the floor covering in a space-saving and flexible manner.

A further development of the aforementioned method, in which the base plate has a first locking element having a first locking portion and the counter plate has a second locking element having a second locking portion, has the following steps:
i. locking the first locking element and the second locking element together by elastic pivoting and/or deforming of one of the locking portions such that the first locking portion is placed against the second locking portion, wherein the elastic connecting device has the at least one locking element having the elastic locking portion;
ii. connecting the first hook-and-loop element and the second hook-and-loop element.

By means of such a method, the base plate and the counter plate can be particularly easily connected.

In a further development of the aforementioned embodiment of the method, the floor covering has a reach-through opening, wherein the elastic connecting device is inserted into the reach-through opening, wherein the base plate is at least partly disposed on a top side of the floor covering, wherein the counter plate is at least partly disposed on a bottom side of the floor covering, which is opposite the top side of the floor covering. This allows the floor mat assembly to be designed flat, so that the installation space required by the floor mat assembly is small.

A further development of the aforementioned embodiment of the method is advantageous in which the at least one locking element of the elastic connecting device is inserted into the reach-through opening. This allows the locking elements to be connected in a particularly space-saving manner.

Further advantages of the invention can be found in the description and the drawings. Likewise, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the Drawings,

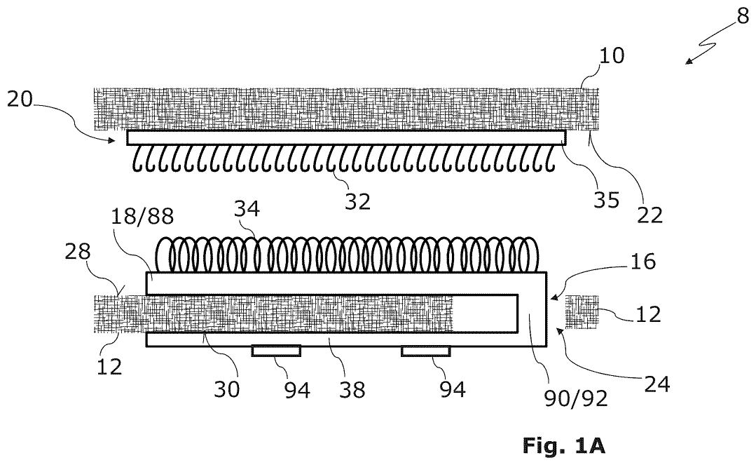

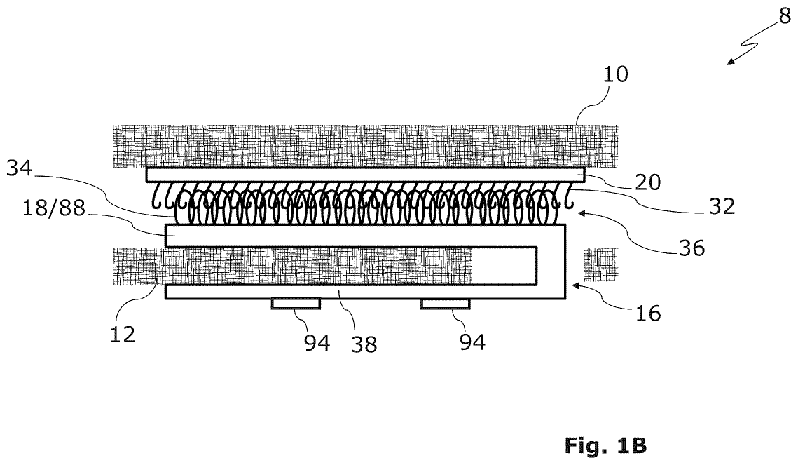

FIG. 1A shows schematically a sectional view through a floor mat assembly in a first embodiment, wherein hook-and-loop elements of the floor mat assembly are separated.

FIG. 1B shows schematically the sectional view through the floor mat assembly from FIG. 1A, wherein the hook-and-loop elements of the floor mat assembly are connected.

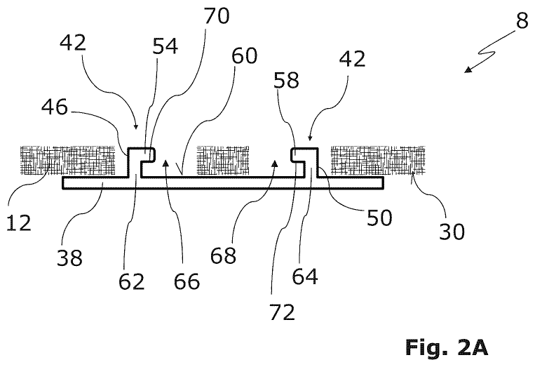

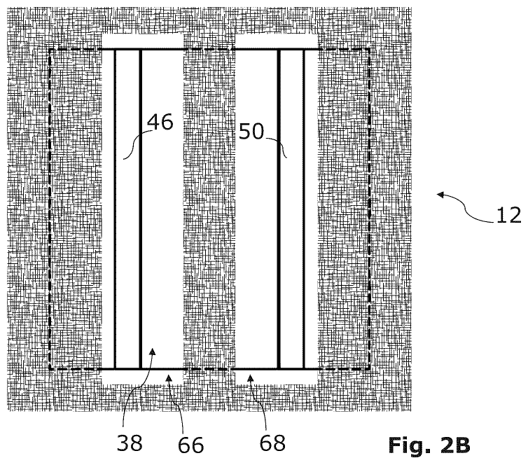

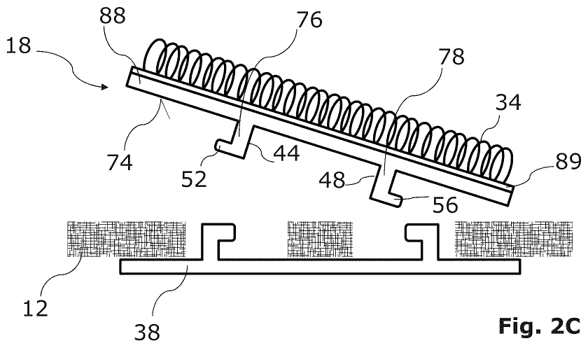

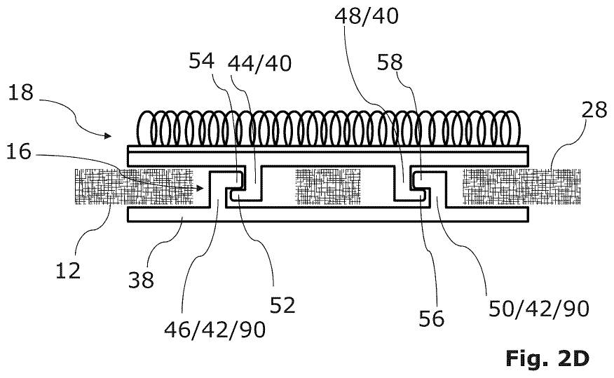

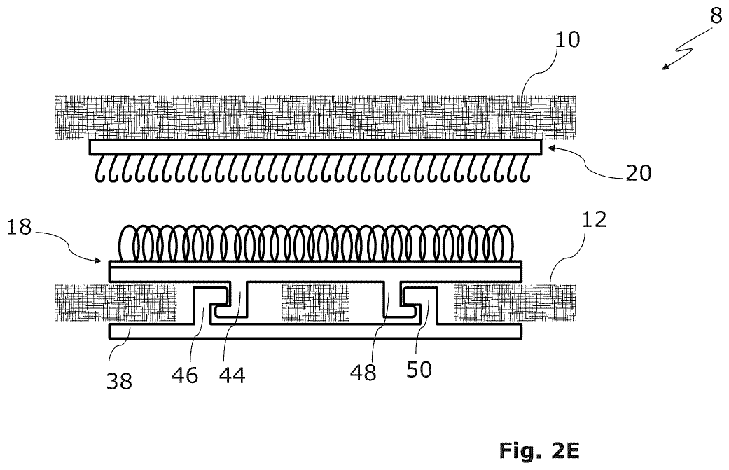

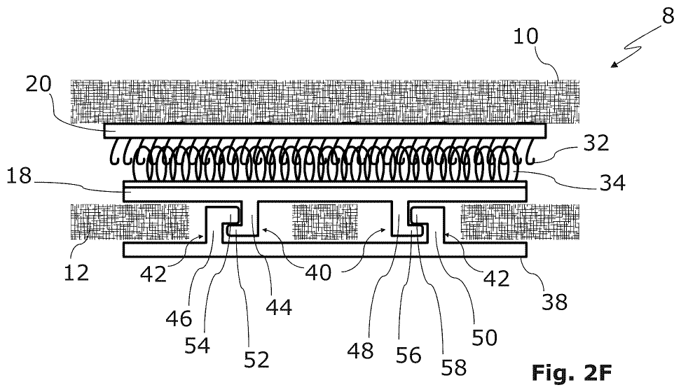

FIG. 2A shows schematically a sectional view through a floor covering and a counter plate of a floor mat assembly in a second embodiment.

FIG. 2B shows schematically a plan view of the floor covering and the counter plate from FIG. 2A.

FIG. 2C shows schematically a sectional view through the counter plate, the floor covering and a first hook-and-loop element of the floor mat assembly in the second embodiment.

FIG. 2D shows schematically a sectional view through the floor covering and through the counter plate connected to the first hook-and-loop element, according to the second embodiment.

FIG. 2E shows schematically a sectional view through the floor mat assembly according to the second embodiment before the connection of a floor mat.

FIG. 2F shows schematically a sectional view through the floor mat assembly from FIG. 2e with the floor mat in the connected state.

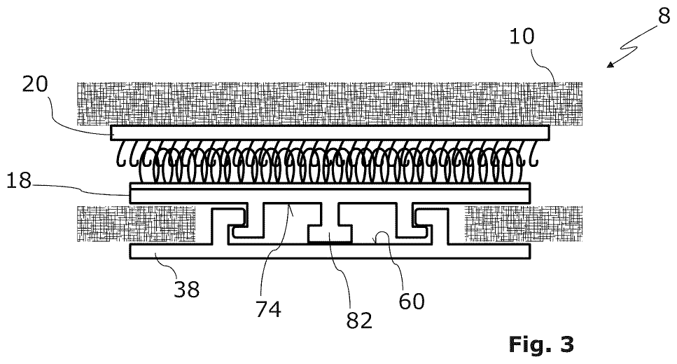

FIG. 3 shows schematically a sectional view through a third embodiment of a floor mat assembly having a support projection.

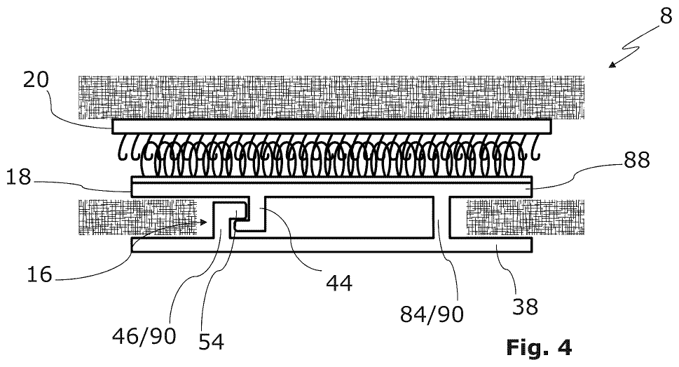

FIG. 4 shows schematically a sectional view through a fourth embodiment of a floor mat assembly having a film hinge.

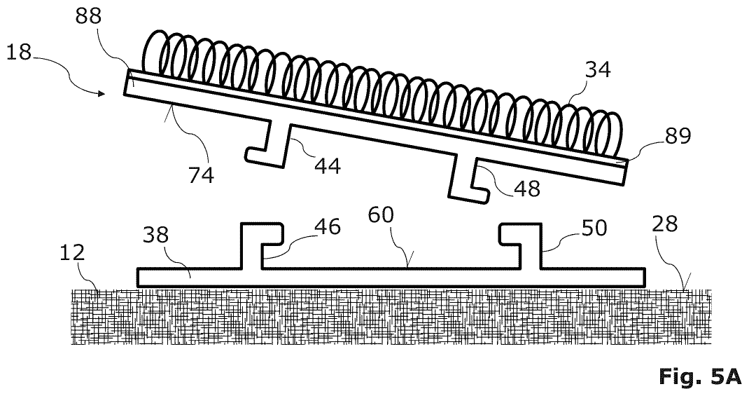

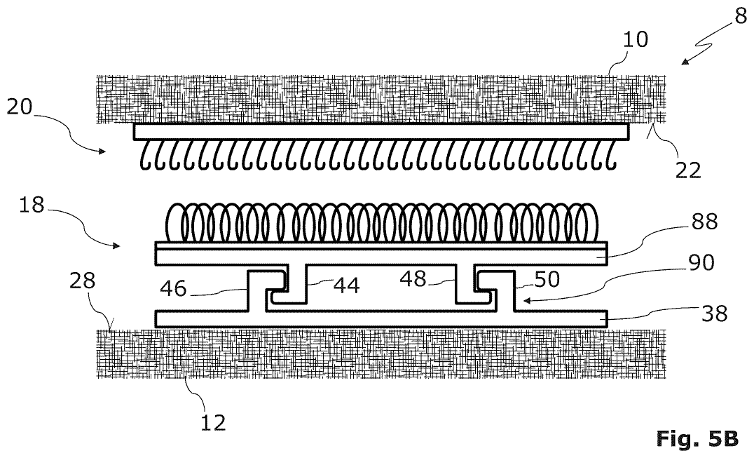

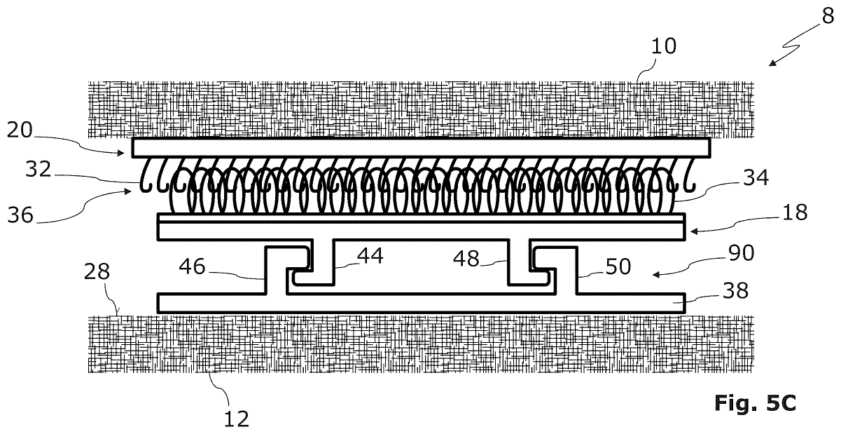

FIG. 5A shows schematically a sectional view through a further arrangement of a first hook-and-loop element, a counter plate and a floor covering.

FIG. 5B shows schematically a sectional view through a fifth embodiment of a floor mat assembly, wherein hook-and-loop elements of the floor mat assembly are separated.

FIG. 5C shows schematically the sectional view through the floor mat assembly from FIG. 5B, wherein the hook-and-loop elements of the floor mat assembly are connected.

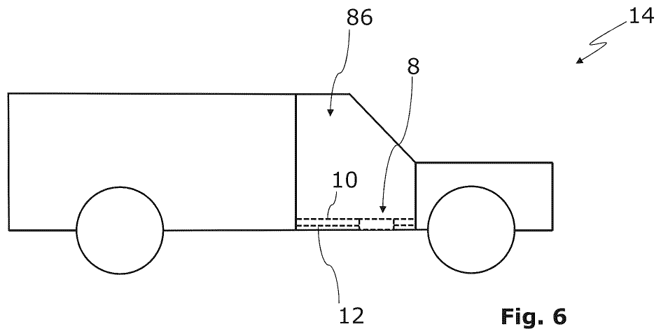

FIG. 6 shows schematically a side view of a vehicle having a floor mat assembly according to the invention.

### DETAILED DESCRIPTION OF PREFERRED EMBODIMENTS

FIG. 1A shows schematically a sectional view through a first embodiment of a floor mat assembly 8. The floor mat assembly 8 has a floor mat 10 and a floor covering 12, the floor covering 12 being fastened to a floor of a vehicle 14 (see FIG. 6). The floor mat assembly 8 has a first hook-and-loop element 18 on the floor covering 12; the first hook-and-loop element 18, which has a base plate 88, is at least partly disposed on a top side 28 the floor covering 12. The floor mat assembly 8 also has a second hook-and-loop element 20 on the bottom side 22 of the floor mat 10. The second hook-and-loop element 20 is fastened, in particular glued or welded, to the bottom side 22 of the floor mat 10.

A counter plate 38 is disposed on a bottom side 30 of the floor covering 12. A connection system 16 connects the base plate 88 and the counter plate 38. The connection system 16 has an elastic connecting device 90. In the embodiment shown, the elastic connecting device 90 is in the form of an elastic connecting web 92 which extends through a reach-through opening 24 in the floor covering 12. In this way, the first hook-and-loop element 18 is firmly anchored in the floor covering 12. A noise protection means 94 can be disposed on the counter plate 38.

The first hook-and-loop element 18 is structured complementarily to the second hook-and-loop element 20 such that the first hook-and-loop element 18 and the second hook-and-loop element 20 can form a hook-and-loop connection 36 (see FIG. 1B) in order to firmly connect the floor mat 10 to the floor covering 12. In the embodiment of the hook-and-loop elements 18, 20 that is shown, the second hook-and-loop element 20 has hooks 32 and the first hook-and-loop element 18 has loops 34 corresponding to the hooks 32; this enables the hook-and-loop connection 36 of the first hook-and-loop element 18 and the second hook-and-loop element 20. In other embodiments, the first hook-and-loop element 18 may have the hooks 32 and the second hook-and-loop element 20 may have the loops 34. The hooks 32 can be part of a hook band 35.

FIG. 1B shows schematically a sectional view through the floor mat assembly 8 having the floor mat 10 and having the flooring mat 12, wherein the counter plate 38 is fastened to the base plate 88 by the connection system 16. The hook-and-loop elements 18, 20 of the floor mat assembly 8 form the hook-and-loop connection 36 in that the hooks 32 of the second hook-and-loop element 20 engage in the loops 34 of the first hook-and-loop element 18.

As explained in more detail below with reference to FIG. 2A to FIG. 2F, the floor mat assembly 8 may in some embodiments have a first locking element 40 and a second locking element 42, in particular with a first, second, third and fourth locking arm 44, 46, 48, 50 (see FIG. 2F). On the locking arms 44, 46, 48, 50, a first, second, third and fourth locking portion 52, 54, 56, 58 may be formed.

FIG. 2A shows schematically a sectional view through a lower part of a floor mat assembly 8 in a second embodiment. The bottom side 30 of the floor covering 12 touches the counter plate 38, the counter plate 38 extending along the bottom side 30 of the floor covering 12. The second locking element 42 is located on the top side 60 of the counter plate 38, the second locking element 42 being formed with the second and fourth locking arms 46, 50, which protrude from the top side 60 of the counter plate 38. The second and fourth locking portions 54, 58 protrude, in particular perpendicularly, from stems 62, 64 of the respective locking arms 46, 50. The locking portions 54, 58 serve to lock the respective locking arms 46, 50. The locking arms 46, 50 are hook-shaped due to the locking portions 54, 58 and reach into respective reach-through openings 66, 68 in the floor covering 12.

The locking portions 54, 58 preferably run parallel to the top side 60 of the counter plate 38. In particular, edges 70, 72 of the locking portions 54, 58, which protrude from the associated stem 62, 64 and run to an outer end of the associated locking portion 54, 58, are oriented parallel to the top side 60 of the counter plate 38. The locking portions 54, 58 on the locking arms 46, 50 are elastically pivotable and/or deformable.

FIG. 2B shows schematically a plan view of the floor covering 12 and the associated counter plate 38. Regions of the counter plate 38 which are covered by the floor covering 12 are indicated by dashed lines. Also shown are the locking arms 46, 50, which reach through the reach-through openings 66, 68 in the floor covering 12.

FIG. 2C shows schematically a sectional view through an embodiment of the first hook-and-loop element 18, which is brought to the counter plate 38 and the floor covering 12 (cf. FIG. 2A) in order to be locked to the counter plate 38. The first and third locking arms 44, 48 protrude, in particular perpendicularly, from the bottom side 74 of a base plate 88 of the first hook-and-loop element 18. The first and third locking portions 52, 56 protrude from the stems 76, 78 of the respective locking arms 44, 48, the locking portions 52, 56 being oriented in particular perpendicularly to the respective stems 76, 78. The locking arms 44, 48 are thus hook-shaped. The locking portions 52, 56 run in particular parallel to the bottom side 74 of the first hook-and-loop element 18. Preferably, a loop band 89 having the loops 34 of the first hook-and-loop element 18 is glued and/or welded to the base plate 88.

FIG. 2D shows schematically a sectional view through the aforementioned embodiment of the first hook-and-loop element 18, which is fastened to the counter plate 38 and abuts the top side 28 of the floor covering 12. The locking portions 52, 54 of the first and second locking arms 44, 46 abut one another, and the locking portions 56, 58 of the third and fourth locking arms 48, 50 abut one another, the locking arms 44, 46, 48, 50 engaging with one another in such a way that they are locked together. Of the locking portions 52, 54, 56, 58 on the locking arms 44, 46, 48, 50 which are locked together, preferably at least one, in each case, is elastically pivotable and/or deformable. This enables the locking arms 44, 46, 48, 50 to be locked together.

By way of example, in the embodiment shown the locking portions 54, 58 of the locking arms 46, 50 are elastic. The elastic connecting device 90 of the connection system 16 then has the locking arms 46, 50 having the elastic locking portions 54, 58.

The locking arms 44, 46, 48, 50, and thus the locking elements 40, 42, are preferably an extrusion profile or part of an extrusion profile.

FIG. 2E shows schematically a sectional view through an embodiment of the floor mat assembly 8 according to the invention. The floor mat assembly 8 has the floor mat 10, the floor covering 12, the first hook-and-loop element 18 and the second hook-and-loop element 20 as well as the counter plate 38, the counter plate 38 being fastened to the first hook-and-loop element 18 by means of the locking arms 44, 46, 48, 50. In the state of the floor mat assembly 8 shown in FIG. 2E, the first hook-and-loop element 18 is separated from the second hook-and-loop element 20. The first hook-and-loop element 18 is brought to the second hook-and-loop element 20 in order to firmly connect the two hook-and-loop elements 18, 20 to one another and to fasten the floor mat 10 to the floor covering 12.

FIG. 2F shows schematically a sectional view through a joined embodiment of the floor mat assembly 8. The floor mat 10 is firmly connected to the floor covering 12 by the floor mat assembly 8. The hooks 32 of the second hook-and-loop element 20 engage in the loops 34 of the first hook-and-loop element 18, the first hook-and-loop element 18 being firmly anchored by the locked locking arms 44, 46, 48, 50 and the counter plate 38 on the floor covering 12. This ensures that the floor mat 10 is fastened to the floor covering 12 in such a way that the floor mat is secured against slipping. As previously mentioned, the first locking arm 44 has the first locking portion 52, the second locking arm 46 has the second locking portion 54, the third locking arm 48 has the third locking portion 56, and the fourth locking arm 50 has the fourth locking portion 58, the locking portions 52, 54, 56 and 58 abutting one another to lock the locking arms 44, 46, 48 and 50, or the locking arms 44, 46, 48, 50 engaging behind one another.

FIG. 3 shows schematically a sectional view through a third embodiment of a floor mat assembly 8, in which a support projection 82 is formed on the bottom side 74 of the first hook-and-loop element 18. Here, the support projection 82 is in the shape of an upside-down “T,” the support projection 82 protruding, in particular perpendicularly, from the bottom side 74 of the first hook-and-loop element 18. The support projection 82 lies flat against the top side 60 of the counter plate 38 in order to stabilize the first hook-and-loop element 18 in the floor mat assembly 8.

FIG. 4 shows schematically a sectional view through a fourth embodiment of a floor mat assembly 8, in which the first hook-and-loop element 18 is designed according to an embodiment in which the first hook-and-loop element 18 has only the first locking arm 44. The counter plate 38 is designed in an embodiment in which the counter plate 38 has only the second locking arm 46. The locking arms 44, 46 engage with one another and are locked together. Furthermore, a film hinge 84 extends from the first hook-and-loop element 18 to the counter plate 38 and integrally connects the first hook-and-loop element 18 and the counter plate 38. Preferably, the counter plate 38 and the base plate 88 are formed integrally with the film hinge 84. This makes the first hook-and-loop element 18 and the counter plate 38 particularly easy to mount.

By way of example, in the embodiment shown the locking portion 54 of the locking arm 46 and the film hinge 84 are elastic. The elastic connecting device 90 of the connection system 16 then has the locking arm 46 having the elastic locking portion 54 and the film hinge 84.

FIG. 5A shows schematically a sectional view through a further arrangement of a first hook-and-loop element 18, a counter plate 38 and a floor covering 12, wherein the first hook-and-loop element 18 is brought to the counter plate 38 and the floor covering 12 in order to be locked to the counter plate 38. The counter plate 38 is fastened on the top side 28 of the floor covering 12, in particular by means of a material bond, e.g. with adhesive or a welded connection. A first and a third locking arm 44, 48 protrude from the bottom side 74 of the base plate 88 of the first hook-and-loop element 18. A second and a fourth locking arm 46, 50 protrude from the top side 60 of the counter plate 38 correspondingly. Preferably, the loop band 89 with the loops 34 of the first hook-and-loop element 18 is glued and/or welded to the base plate 88.

FIG. 5B shows schematically a sectional view through a fifth embodiment of the floor mat assembly 8. The floor mat assembly 8 has a floor mat 10 and the floor covering 12. The floor mat assembly 8 includes the first hook-and-loop element 18 with the base plate 88 and with the counter plate 38 on the top side 28 of the floor covering 12. The base plate 88 and the counter plate 38 are connected to one another by a connecting device 90 in the form of the locked locking arms 44, 46, 48, 50. The floor mat assembly 8 also has the second hook-and-loop element 20, which is fastened to the bottom side 22 of the floor mat 10.

FIG. 5C shows schematically a sectional view through the fifth embodiment of the floor mat assembly 8, wherein the first hook-and-loop element 18 and the second hook-and-loop element 20 form a hook-and-loop connection 36. The floor mat 10 is firmly connected to the floor covering 12 by the floor mat assembly 8. The hooks 32 of the second hook-and-loop element 20 engage in the loops 34 of the first hook-and-loop element 18. The first hook-and-loop element 18 is firmly anchored by the locked locking arms 44, 46, 48, 50 and the counter plate 38 on the top side 28 of the floor covering 12. The counter plate 18 is firmly connected to the floor covering 12 by a material bond. This ensures that the floor mat 10 is fastened to the floor covering 12 in such a way that the floor mat is secured against slipping.

FIG. 6 shows schematically a side view of a vehicle 14 having a floor mat assembly 8 according to the invention according to one of the aforementioned embodiments. The floor mat assembly 8 with the floor covering 12 fixed in the vehicle 14 and with the floor mat 10 in a driver's compartment 86 is shown with dashed lines in FIG. 6.

In view of all the figures in combination, the invention relates in summary to a floor mat assembly 8 having a first hook-and-loop element 18 and a second hook-and-loop element 20 which is at least partly disposed on a bottom side (22) of the floor mat (10). A counter plate 38 is fastened to a floor covering 12. A connection system 16 connects a base plate 88 of the first hook-and-loop element 18 to the counter plate 38. The connection system 16 is at least partly formed with an elastic connecting device 90. The connecting device 90 is preferably formed on a side 74 of the base plate 88 and a side 60 of the counter plate 38, these sides 74, 60 facing one another and lying opposite one another along a connection system axis perpendicular through these sides 74, 60.

Although only a few embodiments of the present invention have been shown and described, it is to be understood that many changes and modifications may be made thereunto without departing from the spirit and scope of the invention.

### LIST OF REFERENCE SIGNS

8 Floor mat assembly
10 Floor mat
12 Floor covering
14 Vehicle
16 Connection system
18 First hook-and-loop element
20 Second hook-and-loop element
22 Bottom side of the floor mat
24 Reach-through opening
28 Top side of the floor covering
30 Bottom side of the floor covering
32 Hook
34 Loops
35 Hook band
36 Hook-and-loop fastening connection
38 Counter plate
40 First locking element
42 Second locking element
44 First locking arm
46 Second locking arm
48 Third locking arm
50 Fourth locking arm
52 First locking portion
54 Second locking portion
56 Third locking portion
58 Fourth locking portion
60 Top side of the counter plate
62 Stem of the second locking arm
64 Stem of the fourth locking arm
66 Reach-through opening
68 Reach-through opening
70 Edge of the locking portion
72 Edge of the locking portion
74 Bottom side of the first hook-and-loop element
76 Stem of the first locking arm
78 Stem of the second locking arm
82 Support projection
84 Film hinge
86 Driver's compartment
88 Base plate of the first hook-and-loop element
89 Loop band
90 Connecting device
92 Connecting web
94 Noise protection means

What is claimed is:

1. A floor mat assembly (8) for a vehicle (14), the floor mat assembly (8) comprising:
a floor covering (12);
a first hook-and-loop element (18) having a base plate (88);
a counter plate (38) which is at least partly disposed on the floor covering (12);
a floor mat (10); and
a second hook-and-loop element (20) which is at least partly disposed on a bottom side (22) of the floor mat (10);
wherein the second hook-and-loop element (20) is connected to the first hook-and-loop element (18) by means of a hook-and-loop connection (36), and
wherein a connection system connects the base plate (88) and the counter plate (38) to one another, the connection system (16) having an elastic connecting device (90), the connecting device (90) extending between mutually facing sides (60, 74) of the base plate (88) and of the counter plate (38).

2. The floor mat assembly according to claim 1, wherein the base plate (88) has a first locking element (40) having a first locking portion (52) and the counter plate (38) has a second locking element (42) having a second locking portion (54),
wherein the elastic connecting device (90) has at least one of the locking elements (40, 42),
wherein the locking portion (52, 54) of the locking element (40, 42) of the elastic connecting device (90) is elastically pivotable and/or deformable,
wherein the first locking element (40) and the second locking element (42) are locked together with the first locking portion (52) abutting the second locking portion (54).

3. The floor mat assembly according to claim 2, wherein the first locking element (40) together with the base plate (88) of the first hook-and-loop element (18) and/or the second locking element (42) together with the counter plate (38) is in the form of an extrusion profile having the associated locking portion (52, 54).

4. The floor mat assembly according to claim 2, wherein the first locking element (40) protrudes from a surface of the first hook-and-loop element (18) toward the counter plate (38) and/or the second locking element (42) protrudes from a surface of the counter plate (38) toward the first hook-and-loop element (18).

5. The floor mat assembly according to claim 2, wherein the first locking element (40) and/or the second locking element (42) has a locking arm (44, 46, 48, 50), wherein each locking arm (44, 46, 48, 50) has a stem (62, 64, 76, 78) from which the associated locking portion (52, 54, 56, 58) protrudes.

6. The floor mat assembly according to claim 5, wherein each locking element (40, 42) that has a locking arm has multiple locking arms (44, 46, 48, 50).

7. The floor mat assembly according to claim 5, wherein the locking portion (52, 54, 56, 58) of the first locking element (40) runs parallel to a side face (74) of the first hook-and-loop element (18) and/or the locking portion (52, 54, 56, 58) of the second locking element (42) runs parallel to a side face (60) of the counter plate (38), wherein each locking arm (44, 46, 48, 50) protrudes from the associated side face (60, 74).

8. The floor mat assembly according to claim 5, wherein multiple locking portions (52, 54, 56, 58) is formed on each locking arm (44, 46, 48, 50).

9. The floor mat assembly according to claim 1, wherein:
the floor covering (12) has a reach-through opening (24, 66, 68);
the base plate (88) is at least partly disposed on a top side (28) of the floor covering (12);
the counter plate (38) is at least partly disposed on a bottom side (30) of the floor covering (12), which is opposite the top side (28) of the floor covering (12);
the second hook-and-loop element (20) is at least partly disposed on a bottom side (22) of the floor mat (10), and
wherein the connection system (16) reaches through the reach-through opening (24, 66, 68).

10. The floor mat assembly according to claim 9, wherein the at least one locking element (40, 42) of the elastic connecting device (90) is inserted into the reach-through opening (24, 66, 68).

11. The floor mat assembly according to claim 1, wherein the counter plate (38) is at least partly fastened to the top side (28) of the floor covering (12) by material bond.

12. The floor mat assembly according to claim 11, wherein the connecting device (90) is at least partly formed between the top side (28) of the floor covering (12) and the bottom side (22) of the floor mat (10).

13. The floor mat assembly according to claim 1, wherein the elastic connecting device (90) has an elastic film hinge (84), and wherein the elastic film hinge (84) connects the counter plate (38) and the base plate (88) to one another.

14. The floor mat assembly according to claim 1, wherein the counter plate (38) and/or the first hook-and-loop element (18) has a support projection (82) which protrudes from an associated surface (60, 74) of the counter plate (38) or of the first hook-and-loop element (18).

15. The floor mat assembly according to claim 1, wherein the counter plate (38) has a noise protection means (94).

16. A vehicle (14) having the floor mat assembly (8) according to claim 1.

17. The vehicle (14) according to claim 16, wherein the counter plate (38) is firmly connected to a floor of the vehicle (14).

18. A method for producing a floor mat assembly (8) for a vehicle (14), the floor mat assembly (8) having:
a floor covering (12);
a first hook-and-loop element (18) having a base plate (88);
a counter plate (38) which is at least partly disposed on the floor covering (12);
a floor mat (10);
a second hook-and-loop element (20) which is at least partly disposed on the bottom side (22) of the floor mat (10);
wherein the second hook-and-loop element (20) becomes connected to the first hook-and-loop element (18) by means of a hook-and-loop connection (36),
wherein the base plate (88) and the counter plate (38) are or become connected to one another by means of a connection system (16),
wherein the connection system (16) has an elastic connecting device (90), and
wherein the elastic connecting device (90) extends between mutually parallel, mutually facing sides (60, 74) of the base plate (88) and of the counter plate (38).

19. The method according to claim 18, wherein the base plate (88) has a first locking element (40) having a first locking portion (52) and the counter plate (38) has a second locking element (42) having a second locking portion (54),
the method comprising the steps of:
i. locking the first locking element (40) and the second locking element (42) together by elastic pivoting and/or deforming of one of the locking portions (40, 42) such that the first locking portion (52) is placed against the second locking portion (54), wherein the elastic connecting device (90) has the at least one locking element (40, 42) having the elastic locking portion (52, 54); and
ii. connecting the first hook-and-loop element (18) and the second hook-and-loop element (20).

20. The method according to claim 19, wherein the floor covering (12) has a reach-through opening (24, 66, 68),
wherein the elastic connecting device (90) is inserted into the reach-through opening (24, 66, 68),
wherein the base plate (88) is at least partly disposed on a top side (28) of the floor covering (12),
wherein the counter plate (38) is at least partly disposed on a bottom side (30) of the floor covering (12), which is opposite the top side (28) of the floor covering (12).

21. The method according to claim 19, wherein the at least one locking element (40, 42) of the elastic connecting device (90) is inserted into the reach-through opening (24, 66, 68).
